(19) United States
(12) Patent Application Publication
(10) Pub. No.: US 2011/0292209 A1
(43) Pub. Date: Dec. 1, 2011

(54) DEVICE AND PROCESS FOR RECOGNIZING CORRECT USE OF AN ALCOHOL-MEASURING DEVICE BY A DRIVER IN A VEHCLE

(75) Inventors: Stefan MORLEY, Lubeck (DE); Johannes LAGOIS, Lubeck (DE); Ingo NEUMANN, Bad Oldesloe (DE); Andreas HUTH, Lubeck (DE)

(73) Assignee: DRAGER SAFETY AG & CO. KGaA, Lubeck (DE)

(21) Appl. No.: 13/079,920

(22) Filed: Apr. 5, 2011

(30) Foreign Application Priority Data
May 31, 2010 (EP) 10 164 441.7

(51) Int. Cl. H04N 7/18

(52) U.S. Cl. 348/148; 348/E07.085

(57) ABSTRACT

A device for recognizing correct use of an alcohol-measuring device by a driver in a vehicle has at least the alcohol-measuring device, an analyzing and control unit and a camera unit. At least an area of the face of the driver can be detected by the image field of the camera unit. The analyzing and control unit is connected to a driving control unit for detecting motion of the vehicle, to the camera unit and to the alcohol-measuring device. The camera unit can be activated by the analyzing and control unit as a function of the driving control unit in such a way that at least the area of the face of the driver is detected.

### CROSS REFERENCE TO RELATED APPLICATIONS

This application claims the benefit of priority under 35 U.S.C. §119 of European Patent Application EP 10 164 441.7 filed May 31, 2010, the entire contents of which are incorporated herein by reference.

### FIELD OF THE INVENTION

The present invention pertains to a device, a process and a system for recognizing correct use of an alcohol-measuring device by a driver in a vehicle and more particularly to an alcohol-measuring device, an analyzing and control unit and a camera unit, wherein at least an area of the face of the driver is detected by the image field of the camera unit.

### BACKGROUND OF THE INVENTION

Alcohol-measuring devices are installed in vehicles (passenger cars, trucks, buses, etc.) combined with a vehicle immobilizer to prevent the vehicle from being put into operation in an unauthorized manner. In particular, starting of the vehicle by a driver who is under the influence of alcohol shall be prevented. Such a device is called an alcohol interlock system.

Interlock systems, in which a camera is additionally provided for documenting the driver, are known from the state of the art. It is thus known, for example, from U.S. Pat. No. 6,748,792 B1 that a camera is provided in a vehicle for taking a picture of the driver during the giving of a breath alcohol sample.

The possibility of manipulation is, in principle, present during the use of an alcohol interlock system. A second person, who is not the driver, could give the breath alcohol sample. To avoid such a possibility of circumvention, prior-art alcohol interlock systems have an alcohol measurement repetition function. This means that the interlock system repeatedly prompts the driver after a randomly generated time period to perform an alcohol measurement.

Alcohol interlock systems with a camera can take a picture of the person giving the sample during this repeated alcohol measurement as well. The drawback of the prior-art alcohol interlock systems with camera is, however, the fact that the picture of the person giving the breath sample is taken at the moment at which the breath sample is given. Even though the person giving the breath sample is thus documented, this person does not also necessarily have to be the driver. A second person, who gives the breath sample in the driver's seat and was also documented by the camera, could leave the driver's seat after the start of the vehicle and a second user, who is under the influence of alcohol, could drive the vehicle.

### SUMMARY OF THE INVENTION

The basic object of the present invention is therefore to make available an alcohol interlock system, by means of which the above-mentioned drawbacks are overcome. In particular, it is the object of the present invention to increase the safety against manipulation of an alcohol interlock system.

The device according to the present invention comprises at least the alcohol-measuring device, an analyzing and control unit and a camera unit, wherein said analyzing and control unit is connected to a driving control unit for recognizing motion of the vehicle, with the camera unit and with the alcohol-measuring device, and the camera unit can be activated by the analyzing and control unit as a function of the driving control unit. At least an area of the face of the test subject can be detected by the image field of the camera unit.

The driver of the vehicle can be documented in an advantageous manner with the device according to the present invention based on the detection and analysis of the motion of the vehicle by the driving control unit and the possibility of activating the camera unit by the analyzing and control unit. The camera unit is set up such that the image field detects at least the area of the face of the test subject.

After an alcohol measurement is performed, the vehicle can be started depending on the result of this measurement. As soon as motion of the vehicle is detected by the drive control unit, the camera unit can be activated by the analyzing and control unit for taking a picture of the driver of the vehicle. The driver of the vehicle can thus be documented in an advantageous manner.

In another advantageous embodiment of the device according to the present invention, the camera unit can be additionally activated by the analyzing and control unit as a function of the alcohol-measuring device for taking a picture of the driver. The camera unit can thus be activated by the analyzing and control unit during or subsequent to an alcohol measurement for taking a picture of the driver as a function of the driving control unit and the alcohol-measuring device.

In yet another preferred embodiment, a data storage unit is provided, in which at least one picture of the driver can be stored.

The analyzing and control unit is designed to poll the driving control unit whether the vehicle is moving. In case of motion of the vehicle, taking a picture of the driver is made possible by the device according to the present invention based on the activation of the camera unit by the analyzing and control unit. This picture can be compared with a previous picture of the driver stored in the memory.

The analyzing and control unit may be designed such that a picture of the driver being stored in the data storage unit is compared with a picture when motion of the vehicle is detected by the driving control unit. In case of lack of agreement of the pictures, the analyzing and control unit may be advantageously connected to a teletransmission unit and designed to transmit these data to a location remote from the vehicle.

The analyzing and control unit may be designed, furthermore, to activate the camera unit after an alcohol measurement and immediately after motion of the vehicle detected by the driving control unit. As an alternative to this, the analyzing and control unit may be designed to activate the camera unit after a minimum travel time. In addition to the minimum travel time, the analyzing and control unit may take into account a minimum speed and/or a minimum acceleration and/or a minimum travel distance for activating the camera unit.

Furthermore, the driver of the vehicle may be asked after a time generated by a random generator to perform another alcohol test. The number of these repeated tests may depend on an overall travel time of the vehicle.

The device according to the present invention makes it possible to reduce the hazard potential of a person driving a vehicle under the influence of alcohol by increasing the safety against manipulation with an alcohol measurement.

The device according to the present invention may be provided in an alcohol interlock system for starting a vehicle, boat or airplane after performance of an alcohol measurement.

The present invention will be explained in more detail with reference to the drawings attached, in which identical reference numbers designate identical features. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an embodiment of the device according to the present invention in a vehicle; and

FIG. 2 is a block diagram of the device according to the present invention in an alcohol interlock system.

### DESCRIPTION OF THE PREFERRED EMBODIMENTS

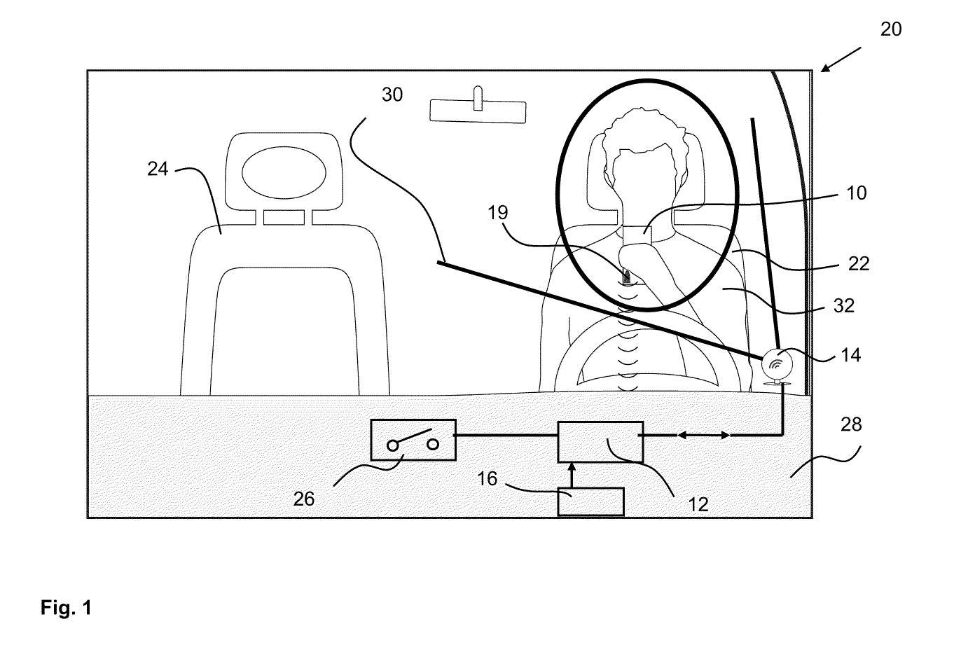

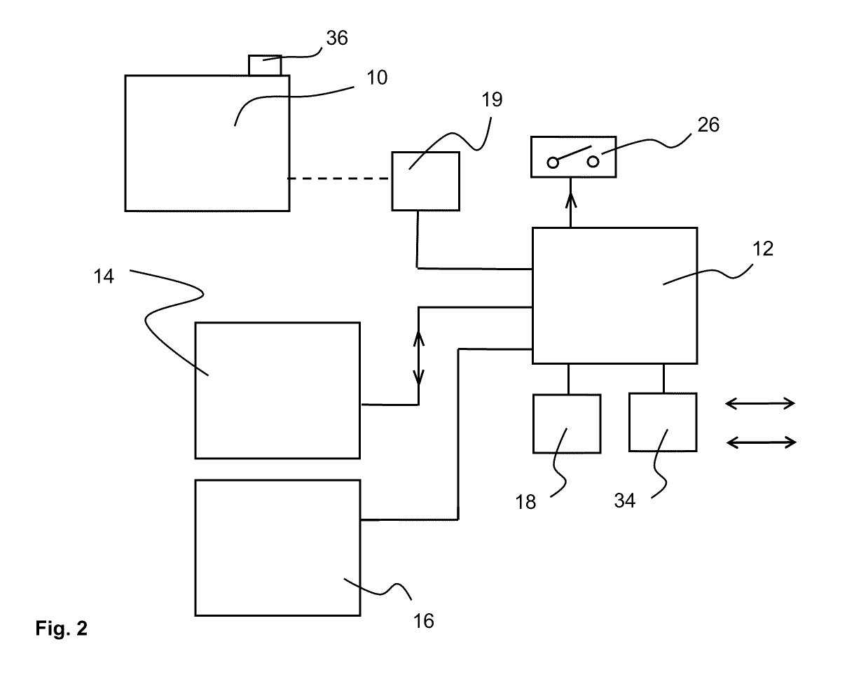

Referring to the drawings in particular, FIG. 1 shows the device according to the present invention for recognizing correct use of an alcohol-measuring device 10 by a driver 32 in a vehicle 20 combined with an alcohol interlock system. FIG. 1 shows the front view of the vehicle 20 with a driver's seat 22 and a passenger seat 24. The alcohol interlock system comprises the alcohol-measuring device 10, an analyzing and control unit 12 (block diagram in FIG. 2) and a starting device 26. The analyzing and control unit 12 is located under a dashboard 28. The analyzing and control unit 12 is provided, among other things, to release or block a starting device 26 of the vehicle 20. The alcohol-measuring device 10 is designed as a breath alcohol-measuring device, which measures the alcohol content in a breath sample given by the driver 32. The driver 32 gives a breath sample through a mouthpiece 36 (FIG. 2) into the alcohol-measuring device 10. The measurement result is transmitted to the analyzing and control unit 12. The transmission takes place via a communications port 19 for wireless communication from the alcohol-measuring device to the analyzing and control unit 12. As an alternative to this, wired communication may also be provided from the alcohol-measuring device 10 to the analyzing and control unit 12. Corresponding to the measurement result obtained for the breath alcohol concentration, the starting means 26 of the vehicle 20 may be released or blocked by the analyzing and control unit 12. The engine of the vehicle 20 can be started with the release of the starting means 26.

A camera unit 14 provided on the dashboard 28 has an image field 30, with which at least an area of the face of the driver 32 can be detected. The analyzing and control unit 12 is connected to a driving control unit 16, camera unit 14 and alcohol-measuring device 10.

The driving control unit 16 is used to detect motion of the vehicle. The camera unit 14 can be activated by the analyzing and control unit 12 depending on the driving control unit 16. The driving control unit 16 may be designed as an acceleration sensor. Reliable information can be obtained with the driving control unit 16 on whether or not the vehicle 20 was moved. As an alternative to this, a satellite-assisted navigation system (not shown) may be provided as a driving control unit 16.

Furthermore, a data storage unit 18 is provided (FIG. 2), in which at least one picture of the driver 32 can be stored. Before starting the vehicle 20, the driver 32 is asked to perform a breath alcohol measurement. The point in time at which the breath alcohol measurement is performed can be recognized by means of a sensor system in the alcohol-measuring device 10 and sent to the analyzing and control unit 12. During the breath alcohol measurement or immediately thereafter, the camera unit 14 can be activated by the analyzing and control unit 12 to take a picture of the driver 32 in the driver's seat 22. The picture is preferably stored in the storage unit 18. A first motion of the vehicle 20 is detected by the driving control unit 16 and this information is sent to the analyzing and control unit 12. The motion of the vehicle 20 is used as a trigger by the analyzing and control unit 12 to activate the camera unit 14. The camera unit 14 takes a picture of the driver 32 in the driver's seat 22.

As an alternative to this, the camera unit 14 may also be activated by the analyzing and control unit 12 with a time delay after detecting motion of the vehicle, for example, after a minimum travel time has been reached. This minimum travel time may be varied in another embodiment by means of a random generator.

Instead of the minimum travel time, a minimum velocity or a minimum acceleration or even a minimum travel distance of the vehicle 20 may also be used as the basis for activation of the camera unit 14 for taking a picture of the driver 32. Furthermore, a combination of the minimum travel time, minimum velocity, minimum acceleration or minimum travel distance is conceivable as well.

A picture of the driver 32 taken by the camera unit 14 is again stored in the data storage unit 18. The picture of the driver 32, which was taken during motion of the vehicle (detected by the driving control unit 16), can be advantageously compared with the picture of the driver 32, which was taken during or immediately after performance of the alcohol measurement. A deviation of the pictures can in turn be documented and sent via a teletransmission unit 34 shown in FIG. 2 to a location remote from the vehicle.

FIG. 2 shows the block diagram of the device according to the present invention in an alcohol interlock system. It appears from the connection of the analyzing and control unit 12 with both the alcohol-measuring device 10 and the camera unit 14 as well as with the driving control unit 16 that the camera unit 14 can be activated by the analyzing and control unit 12 as a function of the driving control unit 16 for taking a picture of the driver 32. The state of motion of the vehicle 20 is consequently determined by means of the driving control unit 16 before a picture is taken by the camera unit 14, sent to the analyzing and control unit 12, which in turn controls the camera unit 14 depending on motion of the vehicle. Furthermore, the complete alcohol interlock system may be connected by means of a teletransmission unit 34 with a central storage unit, to which the pictures taken by the camera unit 14 and/or the results of comparisons of different pictures taken by the camera unit 14 are sent at regular intervals. Criteria for the sending may be both time intervals, for example, days, or the storage capacity of the storage unit 18 integrated in the vehicle 20 or a combination of both.

The use of the device according to the present invention combined with an interlock system in a vehicle 20 represents only one embodiment variant. As an alternative to this, the device according to the present invention may also be integrated in an airplane.

While the present invention was described with reference to the preferred exemplary embodiments, various changes and modifications are clear to the person skilled in the art. All these changes and modifications shall fall within the scope of protection of the claims attached. While specific embodiments of the invention have been shown and described in detail to illustrate the application of the principles of the invention, it will be understood that the invention may be embodied otherwise without departing from such principles.

What is claimed is:

1. A device for recognizing correct use of an alcohol-measuring device by a driver in a vehicle, the device comprising:
an alcohol-measuring device;
an analyzing and control unit;
a camera unit with an image field, wherein at least an area of the face of the driver can be detected by the image field of the camera unit;
a driving control unit for detecting motion of the vehicle, the analyzing and control unit being connected to the driving control unit, to the camera unit and to the alcohol-measuring device, the camera unit being activated by the analyzing and control unit as a function of the driving control unit in such a way that at least the area of the face of the driver is detected.

2. A device in accordance with claim 1, wherein the camera unit is activated by the analyzing and control unit as a function of the alcohol-measuring device for taking a picture of the driver.

3. A device in accordance with claim 1, wherein the driving control unit comprises at least one of an acceleration sensor and a receiver for a satellite-assisted navigation system.

4. A device in accordance with claim 1, wherein the driving control unit is connected to the CAN bus of the vehicle.

5. A device in accordance with claim 1, wherein the camera unit is arranged in the vehicle such that the image field of the camera unit fully covers an area of a driver's seat.

6. A device in accordance with claim 1, further comprising a data storage unit in which at least one picture of the driver is stored.

7. A device in accordance with claim 6, wherein the analyzing and control unit compares a picture of the driver taken by the camera unit in real time with the at least one picture of the driver from the data storage unit.

8. A device in accordance with claim 7, wherein the analyzing and control unit is connected to a teletransmission unit for transmitting data to a location remote from the vehicle.

9. A process for recognizing a correct use of an alcohol-measuring device by a driver in a vehicle, the process comprising the steps of:
providing an alcohol-measuring device;
providing an analyzing and control unit;
providing a camera unit with an image field, wherein at least an area of the face of the driver can be detected by the image field of the camera unit;
providing a driving control unit for detecting motion of the vehicle, the analyzing and control unit being connected to the driving control unit, to the camera unit and to the alcohol-measuring device;
establishing the image field of the camera unit to detect the area of the face of the driver;
detecting motion of the vehicle with the driving control unit; and
activating the camera unit with the analyzing and control unit and taking a picture of the driver as a function of motion of the vehicle.

10. A process in accordance with claim 9, wherein the camera unit is activated by the analyzing and control unit after an alcohol measurement and immediately after motion of the vehicle is detected by the driving control unit.

11. A process in accordance with claim 10, wherein the camera unit is activated by the analyzing and control unit after a repeated alcohol measurement and immediately after motion of the vehicle detected by the driving control unit.

12. A process in accordance with claim 9, wherein the camera unit is activated by the analyzing and control unit after a minimum travel time and/or minimum velocity and/or minimum acceleration and/or minimum travel distance.

13. A process in accordance with claim 9, wherein a picture of the driver is stored in a data storage unit.

14. A process in accordance with claim 13, wherein a real-time picture of the driver is compared with at least one picture of the driver stored in the data storage unit.

15. A process in accordance with claim 9, wherein the analyzing and control unit sends data to a location remote from the vehicle.

16. A system for recognizing correct use of an alcohol-measuring device, the system comprising;
a vehicle with a driver seat;
an alcohol-measuring device connected to the vehicle;
an analyzing and control unit connected to the vehicle;
a camera unit with an image field, wherein at least an area of the face of the driver seated in the driver seat can be detected by the image field of the camera unit;
a driving control unit for detecting motion of the vehicle, the analyzing and control unit being connected to the driving control unit, to the camera unit and to the alcohol-measuring device, the camera unit being activated by the analyzing and control unit as a function of the driving control unit in such a way that at least the area of the face of the driver is detected for recognizing correct use of an alcohol-measuring device by a driver in a vehicle.

17. A system in accordance with claim 16, wherein:
the camera unit is activated by the analyzing and control unit as a function of the alcohol-measuring device for taking a picture of the driver;
the driving control unit comprises at least one of an acceleration sensor and a receiver for a satellite-assisted navigation system.

18. A system in accordance with claim 16, wherein the camera unit is arranged in the vehicle such that the image field of the camera unit fully covers the area of the driver seat.

19. A system in accordance with claim 16, further comprising a data storage unit in which at least one picture of the driver is stored.

20. A system in accordance with claim 19, wherein the analyzing and control unit compares a picture of the driver taken by the camera unit in real time with the at least one picture of the driver from the data storage unit.
